(19) United States
(12) Patent Application Publication
(10) Pub. No.: US 2023/0186051 A1
(43) Pub. Date: Jun. 15, 2023

(54) METHOD AND DEVICE FOR DETERMINING A COVERAGE OF A DATA SET FOR A MACHINE LEARNING SYSTEM WITH RESPECT TO TRIGGER EVENTS

(71) Applicant: Robert Bosch GmbH, Stuttgart (DE)

(72) Inventor: Lydia Gauerhof, Sindelfingen (DE)

(21) Appl. No.: 18/059,204

(22) Filed: Nov. 28, 2022

(30) Foreign Application Priority Data
Dec. 14, 2021 (DE) 10 2021 214 329.6

(51) Int. Cl. G06N 3/042; G06N 3/08

(52) U.S. Cl. CPC G06N 3/042; G06N 3/08

(57) ABSTRACT

A method of evaluating a data set with respect to a coverage of trigger events, which can produce erroneous outputs when processed by a machine learning system. The method includes: providing a semantic domain model as well as a data set;

validating the machine learning system on at least a part of the data set, wherein for recurring incorrect outputs of the machine learning system with the same objects, these objects are identified as trigger events; determining a coverage of the trigger events by the data set depending on the semantic domain model.

### CROSS REFERENCE

The present application claims the benefit under 35 U.S.C. § 119 of German Patent Application No. DE 10 2021 214 329.6 filed on Dec. 14, 2021, which is expressly incorporated herein by reference in its entirety.

### FIELD

The present invention relates to a method for evaluating a data set with respect to a coverage of trigger events, and to a device, a computer program and a storage medium for carrying out the method.

### BACKGROUND INFORMATION

Deep neural networks (DNNs) are increasingly being used in safety-critical applications such as autonomous driving, cancer detection, and secure authentication. With the growing importance of DNNs, there is a need for methods for evaluating and testing the trained DNNs for their suitability in safety-critical applications. Among other things, the evaluation and testing can begin with an evaluation of a quality of a data set, for example in order to suggest a generation of test cases depending thereon in order to evaluate DNNs or to specifically retrain them.

The existing data of a data set for training and/or evaluating the DNNs, possibly do not comprise the entire spectrum that characterize reality, but it is expected that they substantially cover the diversity of reality. Insufficient coverage of the data set can lead to undesirable results, such as biased decisions and algorithmic racism, and create weaknesses that, for example, leave room for opposing attacks.

Asudeh, Abolfazl, Zhongjun Jin, and H. V. Jagadish. “Assessing and remedying coverage for a given dataset.” 2019 IEEE 35th International Conference on Data Engineering (ICDE). IEEE, 2019 describe a method for evaluating a coverage of a particular data set across several categorical attributes.

### SUMMARY

The present invention has the advantage that via linkage between a semantic domain model (SDM) of the data and known malfunctions of the DNN, so-called trigger events, the data set can be easily and reliably evaluated with respect to its coverage.

Further aspects of the present invention and advantageous developments are disclosed herein.

In a first aspect, the present invention relates to a computer-implemented method for evaluating a data set with respect to coverage of trigger events that may produce erroneous outputs when processed by a machine learning system. The term “erroneous output” can be understood to mean that the machine learning system does not generate a correct output that corresponds to the processed input variable. For example, if image classification is performed, a trigger event can result in an incorrect classification. The machine learning system is preferably an already trained or pre-trained machine learning system.

The term “trigger event” can be understood to mean that a particular object or a particular environmental condition in input variables of the machine learning system systematically results in an incorrect output of the machine learning system being produced. The incorrect output can, for example, be present by a false-positive or false-negative output. That is to say, the trigger events cause reproducible and recurring failures. Trigger events are fatal for safety-critical applications since they surely lead to machine learning system failure and can thus result in injuries to persons or even fatal harm, whereas random errors are less serious since they can be reduced to an acceptable probability with extensive training. It is noted that the trigger events are also known as trigger conditions.

According to an example embodiment of the present invention, the method begins with providing a semantic domain model and a data set. The semantic domain model is a model that maps the input space. The data set can be a training data set, i.e., training input variables as well as associated training output variables, labels for short.

This is followed by validating the machine learning system on at least a part of the data set, wherein for recurring incorrect outputs of the machine learning system with the same objects or environmental conditions, these objects or environmental conditions are identified as trigger events.

This is followed by determining a coverage of the trigger events by the data set depending on the semantic domain model. The term “coverage” can be understood to mean that the data set, for example, has the trigger events at a certain percentage.

According to an example embodiment of the present invention, it is provided that depending on the coverage, synthetic data are created that have properties to improve the coverage, and that in particular based on the data set extended by the synthetic data, the machine learning system is retrained.

Furthermore, it is provided that depending on the coverage, it is output whether the data set can be used for training for safety-critical applications or whether the trained machine learning system can be released with this data set for safety-critical applications. In other words, depending on the coverage, a certification of the data set may be issued. It is also conceivable that depending on the coverage, a machine learning system trained based on this data set will be certified for safety-critical use.

Furthermore, according to an example embodiment of the present invention, it is provided that the machine learning system is a classifier or object detector or semantic segmenter. Preferably, the input variables of the machine learning system are images and the machine learning system may be an image classifier or the like.

In another aspect of the present invention, a computer-implemented method for using the machine learning system as a classifier for classifying sensor signals is provided. The classifier is adopted with the method according to one of the preceding aspects of the present invention, with the steps of: receiving a sensor signal comprising data from the image sensor, determining an input signal that depends on the sensor signal, and feeding the input signal into the classifier in order to obtain an output signal characterizing a classification of the input signal.

According to an example embodiment of the present invention, the (image) classifier assigns an input image to one or more classes of a predetermined classification. For example, images of nominally identical products produced in series may be used as input images. For example, the image classifier may be trained to assign the input images to one or more of at least two possible classes representing a quality assessment of the respective product.

The image classifier, e.g., a neural network, may be equipped with a structure such that it can be trained to, for example, identify and distinguish pedestrians and/or vehicles and/or traffic signs and/or traffic lights and/or road surfaces and/or human faces and/or medical abnormalities in imaging sensor images. Alternatively, the classifier, e.g., a neural network, may be equipped with a structure such that it can be trained to identify spoken commands in audio sensor signals.

The term “image” generally includes any distribution of information arranged in a two- or multi-dimensional grid. For example, this information may be intensity values of image pixels captured by means of any imaging modality, such as by means of an optical camera, by means of a thermal imaging camera, or by means of ultrasound. However, any other data, such as audio data, radar data, or LIDAR data, may also be translated into images and then classified equally.

It is furthermore provided that depending on a sensed sensor variable of a sensor, the released machine learning system determines an output variable depending on which a control variable can then be determined, for example by means of a control unit.

The control variable may be used to control an actuator of a technical system. For example, the technical system may be an at least semiautonomous machine, an at least semiautonomous vehicle, a robot, a tool, a machine tool, or a flying object such as a drone. For example, the input variable may be determined based on sensed sensor data and may be provided to the machine learning system. The sensor data may be sensed by a sensor, such as a camera, of the technical system or may alternatively be received externally.

In further aspects, the present invention relates to a device and to a computer program, which are each configured to carry out the above methods, and to a machine-readable storage medium in which said computer program is stored.

Example embodiments of the present invention are explained in greater detail below with reference to the figures.

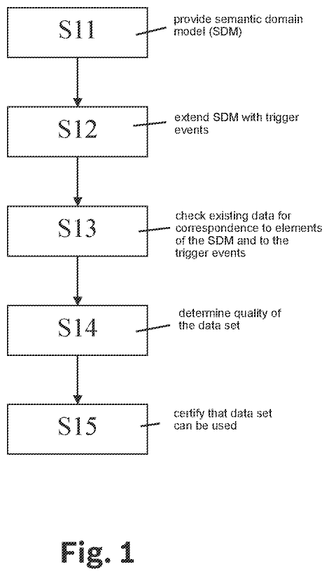

FIG. 1 schematically illustrates a flow chart of one embodiment of the present invention.

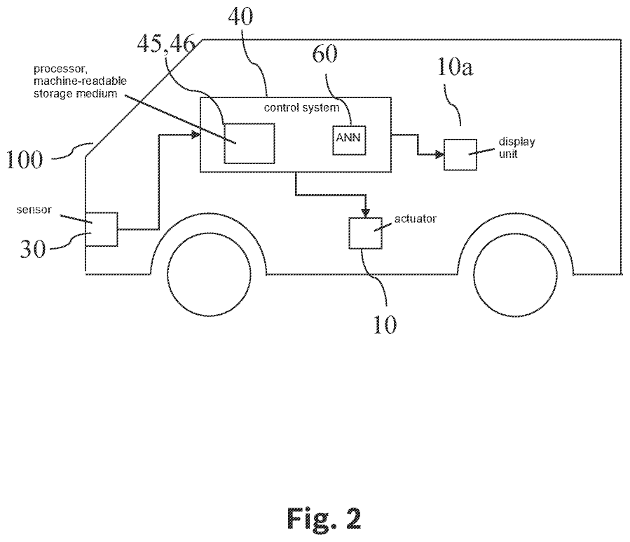

FIG. 2 schematically illustrates an embodiment example for controlling an at least semiautonomous robot, according to the present invention.

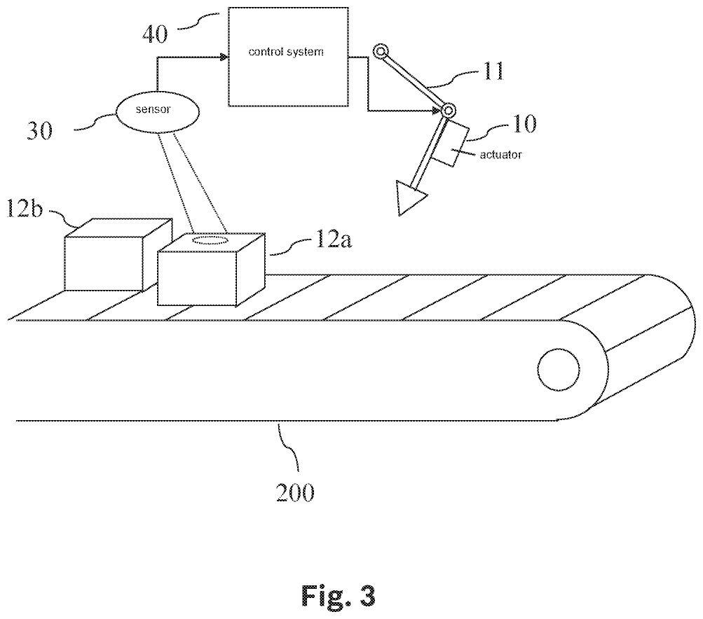

FIG. 3 schematically illustrates an embodiment example for controlling a production system, according to the present invention,

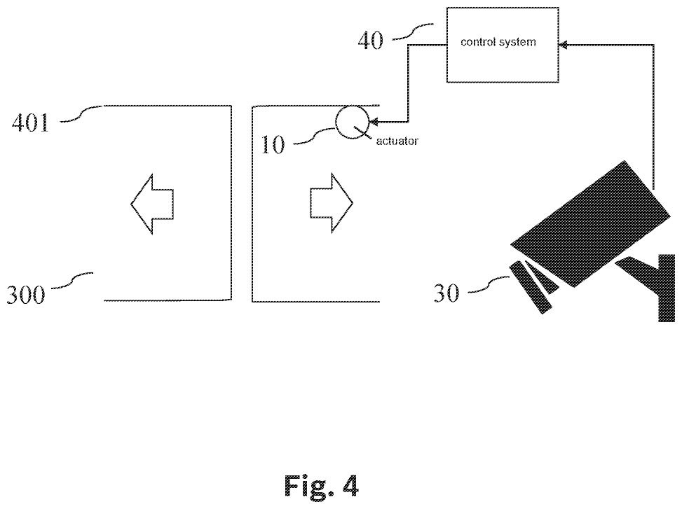

FIG. 4 schematically illustrates an embodiment example for controlling an access system, according to the present invention.

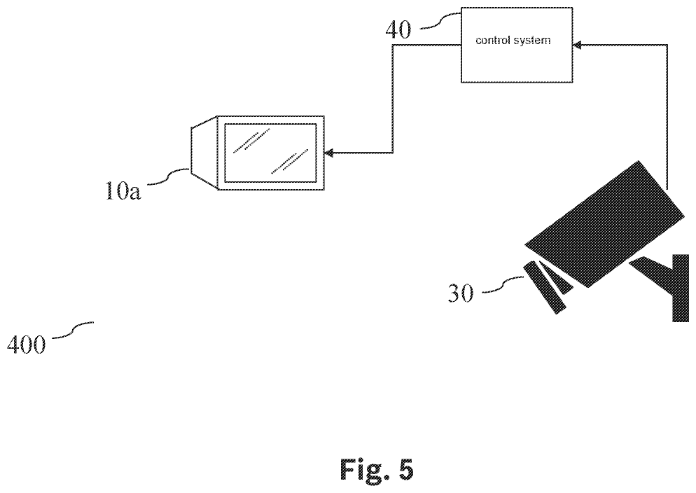

FIG. 5 schematically illustrates an embodiment example for controlling a monitoring system, according of the present invention.

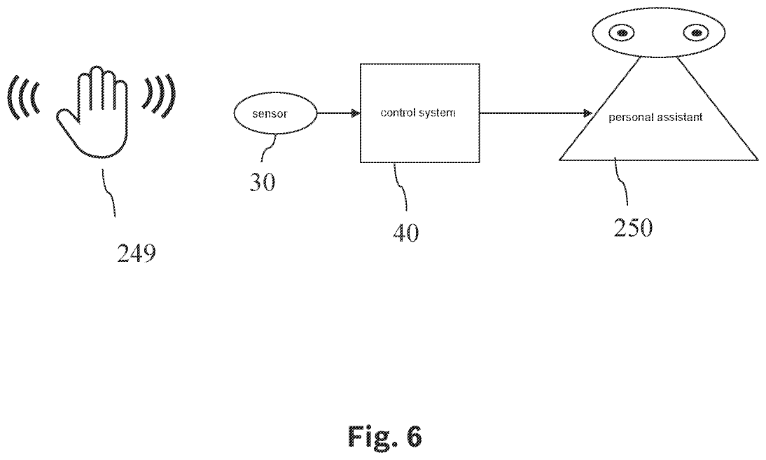

FIG. 6 schematically illustrates an embodiment example for controlling a personal assistant, according to the present invention.

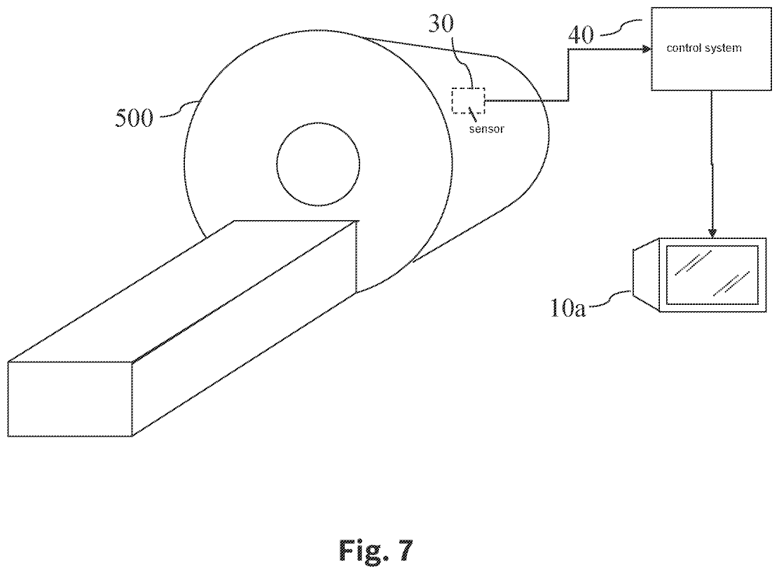

FIG. 7 schematically illustrates an embodiment example for controlling a medical imaging system, according to the present invention.

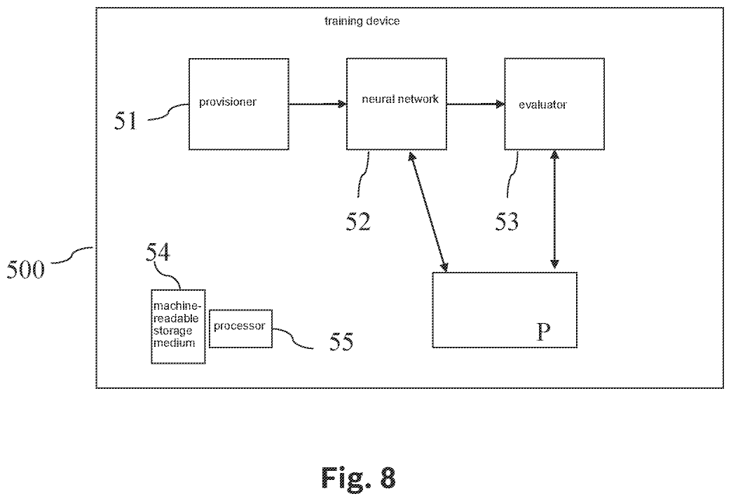

FIG. 8 schematically illustrates a training device, according to an example embodiment of the present invention.

### DETAILED DESCRIPTION OF EXAMPLE EMBODIMENTS

By way of example, FIG. 1 shows a method for evaluating a data set with respect to a coverage of trigger events.

The method starts with step S11. In this step, a semantic domain model (SDM) is provided first. The SDM is a description of an input space of a machine learning system. This input space may be defined by ontology or in a scenario catalog. The SDM may describe potential static and/or dynamic objects in an environment of the machine learning system. Preferably, the SDM is reduced to the relevant objects necessary for a description of the environment, in particular for the respective task of the machine learning system.

An embodiment of the SDM may be a list containing a multiplicity of potential static and/or dynamic objects in the environment. It is conceivable that in addition to each object, the SDM comprises further features of the respective object. For example, the object may be a “pedestrian.” The further feature may, for example, be the pose thereof: “standing,” “walking,” “running,” “supine,” etc. and/or the age thereof, a proportion of the concealment thereof by a nearby object or the like. In addition, the SDM may also comprise properties of sensors that affect, for example, the quality of the data, and/or a condition of the environment, e.g., “raining,” “foggy,” or “sunny.” An example of data quality may be a noise intensity or a type of noise. All descriptions of the input space by the SDM, i.e., the objects and their features, are also referred to hereinafter as elements of the SDM.

There are different approaches for describing input spaces. Zwicky Boxes as a morphological analysis are only one possibility of many.

Then, in the following step S12, the SDM is extended with trigger events. For example, for this purpose, a trained machine learning system that is to be evaluated can be tested with validation data from a data set. The data set may comprise only the validation data or additionally also the training data used to train the machine learning system. The false-positive and/or false-negative results are investigated in order to find the trigger events. For this purpose, conventional methods may, for example, be used to determine which regions or data points of the input variable of the machine learning system resulted in the machine learning system generating the incorrect output. For example, in a pedestrian recognition process, these regions or data points may be posts that are recognized as pedestrians.

Then, in step S13, the existing data used for training and evaluating the machine learning system are checked for their correspondence to the elements of the SDM and to the trigger events. It is understood that for this purpose, the labels of the data of the data set can be considered and compared with the elements of the SDM.

For the check in step S13, a first threshold value may be defined per element or per element combination. An element or element combination of the SDM may then be sufficiently covered by data if a number of data containing the element is greater than or equal to the first threshold value (for example, n=>100 samples). For example: If the SDM contains the elements “pedestrians located on the sidewalk” and “pedestrians located in the intersection,” at least n₁ data must contain pedestrians on the sidewalk and n₂ data must contain pedestrians in the intersection, wherein n₁ and n₂ each represent a first threshold value.

Furthermore, a second threshold value may be defined, wherein the second threshold value is defined for the trigger events and may differ from the first threshold value. For example, m₁ data must then contain a post.

The first and second threshold values may be predetermined or determined by heuristics. A heuristic may be that, for example, the element must occur in at least 2% of the data. Preferably between 2% to 10%. For example, 50, 100, 150, or 200 may be defined as a lower limit not to be undershot for the threshold values.

A quality of the data set is then determined in step S14. The quality may be determined based on the following metrics or based on a link between these metrics:

Metric 1: Coverage of the trigger events by the data set. This may be determined, for example, by a division of a number of the data containing the respective trigger event divided by a total number of the data with or without containing trigger events.

Metric 2: Coverage of data by data comprising trigger events. For example, this may be determined by a division of a number of trigger events, covered by data, by the total number of elements of the SDM contained in the data of the data set.

Metric 3: Coverage of the data with respect to the elements of the SDM. This may be determined, for example, by a division of a number of the data, represented by the SDM, by the number of all elements of the SDM.

It should be noted that further metrics are possible, in particular any linkages or combination of the above metrics. Preferably, the metrics are also dependent on a performance of the machine learning system for the respective elements of the SDM.

In the optional subsequent step S15, depending on the quality of the data set, it may be certified that this data set can be used to train or retrain the machine learning system or that the machine learning system trained with this data set can be used for safety-critical applications. For example, the certification may occur if at least one of the metrics outputs sufficiently high coverage. Depending on the requirements of the task of the machine learning system, a number of metrics that are fulfilled may be pre-determinable so that a minimum coverage is achieved. It should be noted that a training algorithm may also be certified according to step S15.

The following may apply for particularly safety-relevant applications: Only if all metrics output sufficiently high coverage can the assumption be made that the data completely cover the known trigger events and the defined input space, here SDM.

Additionally, or alternatively, changes in the data, in the SDM, and the known trigger events, and their impact on the metrics may also be calculated based on the metrics.

It is also possible that if new trigger events are found, steps S12 and its subsequent steps are carried out again in order to subsequently record these trigger events in the SDM. Additionally, or alternatively, the threshold values may also be readjusted accordingly if trigger events are dropped.

Additionally, or alternatively, the trigger events may be extracted and mitigation of the extracted trigger events may be performed. The mitigation may take place in such a way that an action is selected depending on the type of trigger event in order to correct the incorrect behavior of the DNN. This step may also include performing the action after selecting the action.

Examples of actions include: improving the label quality, post-processing the output of the machine learning system, pre-processing the input data of the machine learning system by, for example, an anomaly detection, etc. or retraining the machine learning system on the supplemented training data set.

In the event that the mitigation of a trigger event was not successful or this trigger event could not be fully mitigated, the corresponding threshold value for this trigger event can be increased as an action.

Additionally, or alternatively, based on the metrics, real data or synthetic data may be added. Depending on the underrepresented objects, the synthetic data may be generated with corresponding features. For example, depending on the respective entries of the SDM, the corresponding data may be generated or rendered by means of a generative neural network or by simulation in order to improve the data set with respect to coverage.

If new trigger events are detected, the SDM can be adjusted (e.g., a new element can be added). Then, the method or parts of the method of FIG. 1 can be carried out again in order to recalculate the coverages.

Finally, the machine learning system can be retrained based on the supplemented training data set. This retrained machine learning system or released machine learning system after step S15 can be used as explained below.

FIG. 2 schematically shows an actuator comprising a control system 40. At preferably regular intervals, an environment 20 of the actuator 10 is sensed by means of a sensor 30, in particular an imaging sensor, such as a video sensor, which may also be given by a plurality of sensors, e.g., a stereo camera. Other imaging sensors are also conceivable, such as radar, ultrasound, or lidar. A thermal imaging camera is also conceivable. The sensor signal S, or one sensor signal S each in the case of several sensors, of the sensor 30 is transmitted to the control system 40. The control system 40 thus receives a sequence of sensor signals S. The control system 40 determines therefrom control signals A, which are transmitted to an actuator 10. The actuator 10 can translate received control commands into mechanical movements or changes of physical variables. The actuator 10 can, for example, translate the control command A into an electrical, hydraulic, pneumatic, thermal, magnetic, and/or mechanical movement or cause change. Specific but non-limiting examples include electric motors, electroactive polymers, hydraulic cylinders, piezoelectric actuators, pneumatic actuators, servomechanisms, solenoids, stepper motors, etc.

The control system 40 receives the sequence of sensor signals S of the sensor 30 in an optional reception unit 50, which converts the sequence of sensor signals S into a sequence of input images x (alternatively, the sensor signal S can also respectively be immediately adopted as an input image x). For example, the input image x may be a section or a further processing of the sensor signal S. The input image x comprises individual frames of a video recording. In other words, input image x is determined depending on the sensor signal S. The sequence of input images x is supplied to the retrained machine learning system, an artificial neural network 60 in the embodiment example.

The artificial neural network 60 is preferably parameterized by parameters stored in and provided by a parameter memory.

The artificial neural network 60 determines output variables y from the input images x. These output variables y may in particular comprise classification and/or semantic segmentation of the input images x. Output variables y are supplied to an optional conversion unit 80, which therefrom determines control signals A, which are supplied to the actuator 10 in order to control the actuator 10 accordingly. Output variable y comprises information about objects that were sensed by the sensor 30.

The actuator 10 receives the control signals A, is controlled accordingly, and carries out a corresponding action. The actuator 10 can comprise a control logic (not necessarily structurally integrated) which determines, from the control signal A, a second control signal by means of which the actuator 10 is then controlled.

In further embodiments, the control system 40 comprises the sensor 30. In yet further embodiments, the control system 40 alternatively or additionally also comprises the actuator 10.

In further preferred embodiments, the control system 40 comprises a single processor 45 or a plurality of processors 45 and at least one machine-readable storage medium 46 in which instructions are stored that, when executed on the processors 45, cause the control system 40 to carry out the method according to the invention.

In alternative embodiments, as an alternative or in addition to the actuator 10, a display unit 10a is provided, which can indicate an output variable of the control system 40.

In other embodiments, the display unit 10a can be an output interface to a rendering device, such as a display, a light source, a speaker, a vibration motor, etc., which can be used to generate an output signal that can be sensed, e.g., for use in guiding, navigating, or otherwise controlling a computer-controlled system.

In a preferred embodiment of FIG. 2, the control system 40 is used to control the actuator, which is here one of an at least semiautonomous robot, here of an at least semiautonomous motor vehicle 100. The sensor 30 may, for example, be a video sensor preferably arranged in the motor vehicle 100.

The actuator 10, preferably arranged in the motor vehicle 100, may, for example, be a brake, a drive, or a steering of the motor vehicle 100. The control signal A may then be determined in such a way that the actuator or actuators 10 is controlled in such a way that, for example, the motor vehicle 100 prevents a collision with the objects reliably identified by the artificial neural network 60, in particular if they are objects of specific classes, e.g., pedestrians.

Alternatively, the at least semiautonomous robot may also be another mobile robot (not shown), e.g., one that moves by flying, swimming, diving, or walking. For example, the mobile robot may also be an at least semiautonomous lawnmower or an at least semiautonomous cleaning robot. In these cases as well, the control signal A can be determined in such a way that drive and/or steering of the mobile robot are controlled in such a way that the at least semiautonomous robot, for example, prevents a collision with objects identified by the artificial neural network 60.

FIG. 3 shows an embodiment example in which the control system 40 is used to control a production machine 11 of a production system 200 by controlling an actuator 10 controlling said production machine 11. For example, the production machine 11 may be a machine for punching, sawing, drilling, milling, and/or cutting.

The sensor 30 may then, for example, be an optical sensor that, for example, senses properties of manufacturing products 12a, 12b. It is possible that these manufacturing products 12a, 12b are movable. It is possible that the actuator 10 controlling the production machine 11 is controlled depending on an assignment of the sensed manufacturing products 12a, 12b so that the production machine 11 carries out a subsequent machining step of the correct one of the manufacturing products 12a, 12b accordingly. It is also possible that, by identifying the correct properties of the same one of the manufacturing products 12a, 12b (i.e., without misassignment), the production machine 11 accordingly adjusts the same production step for machining a subsequent manufacturing product.

FIG. 4 shows an embodiment example in which the control system 40 is used to control an access system 300. The access system 300 may comprise a physical access control, e.g., a door 401. Video sensor 30 is configured to sense a person. By means of the object identification system 60, this captured image can be interpreted. If several persons are sensed simultaneously, the identity of the persons can be determined particularly reliably by associating the persons (i.e., the objects) with one another, e.g., by analyzing their movements. The actuator 10 may be a lock that, depending on the control signal A, releases the access control, or not, e.g., opens the door 401, or not. For this purpose, the control signal A may be selected depending on the interpretation of the object identification system 60, e.g., depending on the determined identity of the person. A logical access control may also be provided instead of the physical access control.

FIG. 5 shows an embodiment example in which the control system 40 is used to control a monitoring system 400. From the embodiment example shown in FIG. 5, this embodiment example differs in that instead of the actuator 10, the display unit 10a is provided, which is controlled by the control system 40. For example, the artificial neural network 60 can reliably determine an identity of the objects captured by the video sensor 30, in order to, for example, infer depending thereon which of them are suspicious, and the control signal A can then be selected in such a way that this object is shown highlighted in color by the display unit 10a.

FIG. 6 shows an embodiment example in which the control system 40 is used to control a personal assistant 250. The sensor 30 is preferably an optical sensor that receives images of a gesture of a user 249.

Depending on the signals of the sensor 30, the control system 40 determines a control signal A of the personal assistant 250, e.g., by the neural network performing gesture recognition. This determined control signal A is then transmitted to the personal assistant 250 and the latter is thus controlled accordingly. This determined control signal A may in particular be selected to correspond to a presumed desired control by the user 249. This presumed desired control can be determined depending on the gesture recognized by the artificial neural network 60. Depending on the presumed desired control, the control system 40 can then select the control signal A for transmission to the personal assistant 250 and/or select the control signal A for transmission to the personal assistant according to the presumed desired control 250.

This corresponding control may, for example, include the personal assistant 250 retrieving information from a database and receptably rendering it to the user 249.

Instead of the personal assistant 250, a domestic appliance (not shown) may also be provided, in particular a washing machine, a stove, an oven, a microwave or a dishwasher, in order to be controlled accordingly.

FIG. 7 shows an embodiment example in which the control system 40 is used to control a medical imaging system 500, e.g., an MRT, X-ray, or ultrasound device. For example, the sensor 30 may be given by an imaging sensor, and the display unit 10a is controlled by the control system 40. For example, the neural network 60 may determine whether an area captured by the imaging sensor is abnormal, and the control signal A may then be selected in such a way that this area is presented highlighted in color by the display unit 10a.

FIG. 8 schematically illustrates a training device 500 comprising a provisioner 51 that provides from a training data set, for example certified according to the method of FIG. 1. In one embodiment example, the training data are input images that are supplied to the neural network 52 to be trained, which determines output variables therefrom. Output variables and input images are supplied to an evaluator 53, which determines updated hyper-/parameters therefrom, which are transmitted to the parameter memory P and replace the current parameters there.

The methods carried out by the training device 500 may be stored, implemented as a computer program, in a machine-readable storage medium 54 and may be executed by a processor 55.

The term “computer” comprises any device for processing pre-determinable calculation rules. These calculation rules may be present in the form of software, in the form of hardware or also in a mixed form of software and hardware.

What is claimed is:

1. A method of evaluating a data set with respect to its coverage of trigger events, which can produce erroneous outputs when processed by a machine learning system, the method comprising the following steps:
providing a semantic domain model (SDM) and the data set;
validating the machine learning system on at least a part of the data set, wherein for recurring incorrect outputs of the machine learning system with the same objects or the same environmental conditions, the objects or environmental conditions are identified as trigger events; and
determining a coverage of the trigger events by the data set depending on the semantic domain model.

2. The method according to claim 1, wherein the coverage is determined based on metrics, wherein the metrics characterize a coverage of the trigger events by the data set and/or a coverage of the trigger events with respect to elements of the SDM and/or coverage of the data with respect to the elements of the SDM.

3. The method according to claim 1, wherein the semantic domain model characterizes a description of an input space including an environment of the machine learning system.

4. The method according to claim 1, wherein synthetic data are created depending on the coverage, and the machine learning system is retrained based on the extended data set by the synthetic data.

5. The method according to claim 1, further comprising:
depending on the coverage, outputting whether the data set can be used for training for safety-critical applications or whether the trained machine learning system can be released with the data set for safety-critical applications.

6. The method according to claim 5, further comprising:
based on the data set being used for a safety-critical application, controlling a technical system depending on determined outputs of the machine learning system.

7. The method according to claim 1, wherein the input variables are images and the machine learning system is an image classifier.

8. A device configured to evaluate a data set with respect to its coverage of trigger events, which can produce erroneous outputs when processed by a machine learning system, the device configured to:
provide a semantic domain model (SDM) and the data set;
validate the machine learning system on at least a part of the data set, wherein for recurring incorrect outputs of the machine learning system with the same objects or the same environmental conditions, the objects or environmental conditions are identified as trigger events; and
determine a coverage of the trigger events by the data set depending on the semantic domain model.

9. A non-transitory machine-readable storage medium on which is stored a computer program for evaluating a data set with respect to its coverage of trigger events, which can produce erroneous outputs when processed by a machine learning system, the computer program, when executed by a computer, causing the computer to perform the following steps:
providing a semantic domain model (SDM) and the data set;
validating the machine learning system on at least a part of the data set, wherein for recurring incorrect outputs of the machine learning system with the same objects or the same environmental conditions, the objects or environmental conditions are identified as trigger events; and
determining a coverage of the trigger events by the data set depending on the semantic domain model.
